(19) United States
(12) Patent Application Publication
(10) Pub. No.: US 2009/0212940 A1
(43) Pub. Date: Aug. 27, 2009

(54) METHOD OF WIRELESS ALARM FOR MEDICAL ALARM SYSTEM

(76) Inventor: Donny CHUNG, Taipei (TW)

Correspondence Address: HDLS Patent & Trademark Services, P.O. BOX 220746, CHANTILLY, VA, 20153-0746, US

(21) Appl. No.: 12/038,161

(22) Filed: Feb. 27, 2008

(51) Int. Cl. G08B 1/08

(52) U.S. Cl. 340/539.12; 340/539.13

(57) ABSTRACT

A method of a wireless alarm for a medical alarm system, and the alarm system is installed with a network module and a cell phone module. An alarm signal is remotely transmitted to a computer or a portable apparatus by the network module on Internet or is remotely transmitted to a cell phone of by the cell phone module through a GPRS when an unusual environmental condition is detected by the alarm system. This method enhances alarm efficiency of the alarm system.

### BACKGROUND OF THE INVENTION

1. Field of the Invention

The present invention relates to an alarm method, and more particularly to a wireless alarm method.

2. Description of the Prior Art

Alarm has been widely applied in various fields to announce supervisors so as to quickly handle or even remedy an emergency. In hospitals, there are various environmental data, such as the contents of gases including oxygen, nitrogen, and nitrous oxide, or temperature, humidity, gas concentration, etc., which have to be detected and analyzed whether abnormal conditions arise. Hence, an alarm system is provided to detect an unusual environmental condition so as to protect safety of patients and medical personnel.

Reference is made to FIG. 1 which is a block diagram of a prior art alarm apparatus. The alarm apparatus 10 comprises a control unit 101, a detection unit 102, a relay unit 103, and a display unit 104. The detection unit 102 is used to detect environmental conditions in sickrooms, and the detected data are delivered to the control unit 101. The detected data are further analyzed by the control unit 101 and then are delivered to the display unit 104 to be displayed. The control unit 101 is further connected to the relay unit 103 and the relay unit 103 is connected to other external alarm systems (not shown) so as to deliver alarm signals, or is connected to a master alarm (not shown) so as to monitor all of the sickrooms in a hospital. Hence, an alarm signal is generated and stored by the control unit 101 when an unusual environmental condition is detected by the detection unit 102. Afterward, the alarm signal is displayed on the display unit 104, or the alarm signal is delivered to activate the master alarm by the relay unit 103 so as to announce supervisors.

However, the prior art alarm apparatus 10 has the disadvantages:

The supervisor must monitor the displayers continuously and can not be away from the display, otherwise the alarm signal may be neglected, thus causing probable emergency. If a hospital has a plurality of district branches, the detected environmental data of each district branches are stored by control units thereof so that all alarm apparatuses of the branch hospitals have to be connected to external hosts and to be monitored via the Internet. Hence, some apparatuses, such as hosts, and network apparatuses, etc. have to additionally purchase and equipment costs increase. Besides, a large amount of data are delivered on Internet is not only easily to raise unstable operation but probably to cause virus infection. Furthermore, it is inconvenient to complete data communication of all branch hospitals.

### SUMMARY OF THE INVENTION

The primary object of the present invention is to provide a method of a wireless alarm for a medical alarm system, wherein an alarm signal is transmitted to a cell phone of a supervisor through a general packet radio service (GPRS) when an unusual environmental condition is detected by the alarm system. Hence, the unusual environmental condition can be quickly handled or even remedied when the alarm signal is identified by the supervisor.

The another object of the present invention is to provide a method of a wireless for a medical alarm system, wherein the alarm signal is remotely transmitted to the alarm system on Internet without any external host so that the alarm signal can be displayed and monitored on any one display module of the alarm system by the supervisor.

To achieve the objectives mentioned above, a network module and a cell phone module are installed in the alarm system. An alarm signal is remotely transmitted to personal computers or portable apparatuses by the network module on Internet or is remotely transmitted to cell phones of by the cell phone module through a GPRS when an unusual environmental condition is detected by the alarm system.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a block diagram of a prior art alarm apparatus;

FIG. 2 is a block diagram of an alarm system according to the present; and

FIG. 3 is a flowchart of a method for a medical alarm system.

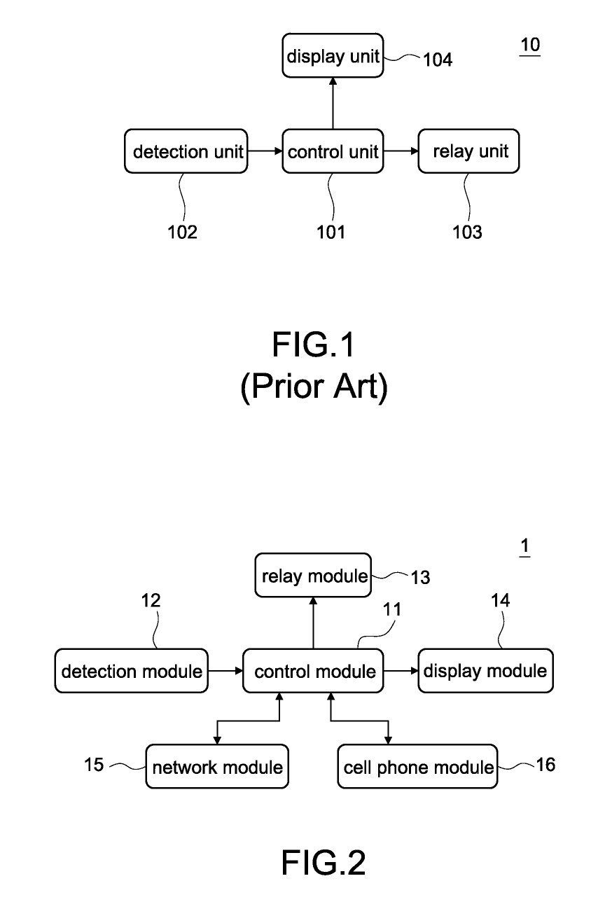

The drawings will be described further in connection with the following detailed description of the present invention.

### DETAILED DESCRIPTION OF THE PREFERRED EMBODIMENTS

The present invention is to provide a method of a wireless alarm to remotely transmit alarm signals. An alarm signal is displayed on a display unit and is also delivered to remote apparatuses when an unusual environmental condition is detected.

Reference is made to FIG. 2 which is a block diagram of an alarm system according to the present. The alarm system comprises a control module 11 and a plurality of input/output (I/O) modules. The control module is used to process the environmental data by an embedded operating systems, and mainly comprises following components.

1. A detection module 12 is used to detect various environmental data, such as the contents of oxygen, nitrogen, and nitrous oxide, or temperature, humidity, gas concentration, etc., and the data are delivered to the control module 11 to identify whether the detected data exceed testing standards after analyzing the environmental data.

2. A display module 13 is used to display the detected environmental data and display an alarm signal generated from the control module 11.

3. A relay module 14 is used to connect to other apparatuses and deliver alarm signals to other apparatuses.

4. A network module 15 is used to remotely transmit the alarm signal to external apparatuses, such as personal computers, or portable apparatuses, etc., on Internet without any external host.

5. A cell phone module 16 is used to remotely transmit the alarm signal to cell phones of a supervisor through a GPRS.

Although the present invention has been described with reference to the preferred embodiment thereof, it will be understood that the invention is not limited to the details thereof.

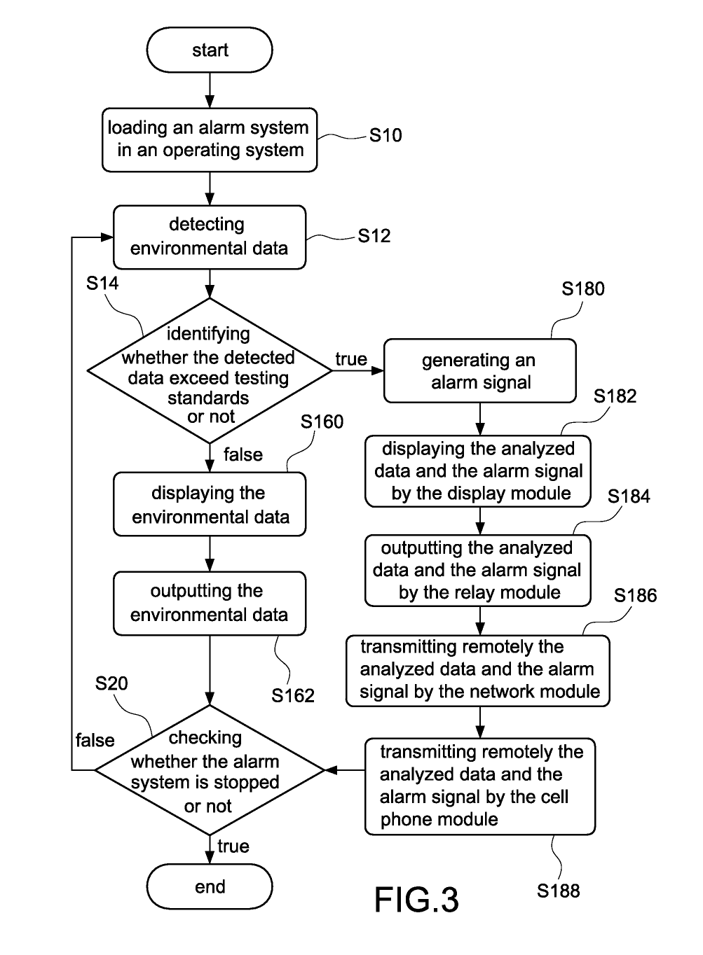

Reference is made to FIG. 3 which is a flowchart of a method for a medical alarm system. The alarm system is loaded with an operating system of the control module (S10) when the alarm system is started for operation. A detection module is used to detect various environmental data (S12) and the detected data are continuously delivered to the control module to identify whether the detected data exceed testing standards after analyzing the data (S14). The analyzed data are delivered to a display module for displaying thereon when the environmental data matches with the testing standard (S160) (namely, there is no any potential emergency in the detected area). The analyzed environmental data are outputted from a relay module to external apparatuses for display or further analysis (S162). Finally, the procedure checks whether the alarm system is stopped or not (S20).

In the step (S14), an alarm signal is generated and stored by the control module (S180) when the environmental data do not match with the testing standard (namely, there is potential emergency in the detected area). Afterward, the analyzed data and the alarm signal are delivered to the display module for displaying thereon (S182). The analyzed data and the alarm signal are outputted from the relay module to external apparatuses for display or further caution. The alarm signal is remotely transmitted to external apparatuses, such as computers or portable apparatuses by the network module on Internet (S186). Furthermore, the alarm signal is remotely transmitted to external apparatuses, such as cell phones by the cell phone module through a GPRS (S188).

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of a wireless alarm for a medical alarm system, the alarm system installed with a network module and a cell phone module, the method comprising the steps of:
a. detecting environmental data by using a detection module of the alarm system;
b. determining whether the environmental data matches with a testing standard or not;
c. outputting the environmental data when the environmental data are matched with the testing standard after the step (b);
d. generating an alarm signal when the environmental data are not matched with the testing standard after the step (b);
e. outputting the alarm signal after the step (d);
f. transmitting remotely the alarm signal after the step (d).

2. The wireless alarm method in claim 1, wherein in the step (c) the environmental data are displayed on a display module of the alarm system.

3. The wireless alarm method in claim 1, wherein in the step (c) the environmental data are outputted from a relay module of the alarm system.

4. The wireless alarm method in claim 1, wherein in the step (e) the alarm signal is displayed on the display module of the alarm system.

5. The wireless alarm method in claim 1, wherein in the step (e) the alarm signal is outputted from a relay module of the alarm system.

6. The wireless alarm method in claim 1, wherein in the step (f) the alarm signal is remotely transmitted by the network module on Internet.

7. The wireless alarm method in claim 1, wherein in the step (f) the alarm signal is remotely transmitted by the cell phone module through a general packet radio service (GPRS).

8. The wireless alarm method in claim 1, wherein the step (d) further comprising the sub-step of:
d1. storing the alarm signal.

9. The wireless alarm method in claim 1, further comprising the step of:
g. outputting the environmental data after the step (d).

10. The wireless alarm method in claim 9, wherein in the step (g) the environmental data are displayed on the display module of the alarm system.

11. The wireless alarm method in claim 9, wherein in the step (g) the environmental data are outputted from a relay module of the alarm system.

12. The wireless alarm method in claim 1, further comprising the step of:
h. transmitting remotely the environmental data after the step (d).

13. The wireless alarm method in claim 12, wherein in the step (h) the alarm signal is remotely transmitted by the network module on Internet.

14. The wireless alarm method in claim 12, wherein in the step (h) the alarm signal is remotely transmitted by the cell phone module through the general packet radio service (GPRS).

15. A method of a wireless alarm for a medical alarm system, the alarm system installed with a network module and a cell phone module, the method comprising the steps of:
a. detecting various environmental data by using a detection module of the alarm system;
b. transmitting the environmental data to a control module of the alarm system;
c. determining whether the environmental data matches with a testing standard or not by the control module;
d. generating an alarm signal by the control module when the environmental data are not matches with the testing standard after the step (c);
e. storing the alarm signal in the alarm system;
f. transmitting remotely the alarm signal by the network module on Internet; and
g. transmitting remotely the alarm signal by the cell phone module through a general packet radio service (GPRS).

16. The wireless alarm method in claim 15, further comprising the step of:
h. displaying the alarm signal on a display module of the alarm system.

17. The wireless alarm method in claim 15, further comprising the step of:
h. outputting the alarm signal from a relay module of the alarm system.
